(19) United States
(12) Patent Application Publication
(10) Pub. No.: US 2021/0152437 A1
(43) Pub. Date: May 20, 2021

(54) INFORMATION PROCESSING APPARATUS, DATA FLOW EDITING METHOD, AND STORAGE MEDIUM

(71) Applicant: FUJITSU LIMITED, Kawasaki-shi (JP)

(72) Inventors: FEI CHEN, Kawasaki (JP); Takayuki Kitano, Hachioji (JP)

(73) Assignee: FUJITSU LIMITED, Kawasaki-shi (JP)

(21) Appl. No.: 17/074,665

(22) Filed: Oct. 20, 2020

(30) Foreign Application Priority Data
Nov. 19, 2019 (JP) 2019-208702

(51) Int. Cl. H04L 12/24; G06F 3/0484

(52) U.S. Cl. CPC H04L 41/22; G06F 3/0484

(57) ABSTRACT

An information processing apparatus, includes a memory; and a processor coupled to the memory and configured to: count a number of first data flows which a second data flow related to a current data flow has, repeat a replacement processing which replaces the current data flow with the second data flow until the counted number of first data flows is not 1, when the number of first data flows of the second data flow is not 1, identify the second data flow as the current data flow, and display the identified current data flow on a display device.

### CROSS-REFERENCE TO RELATED APPLICATION

This application is based upon and claims the benefit of priority of the prior Japanese Patent Application No. 2019-208702, filed on Nov. 19, 2019, the entire contents of which are incorporated herein by reference.

### FIELD

The embodiment discussed herein is related to an information processing apparatus, a data flow editing method, and a storage medium.

### BACKGROUND

In recent years, companies have been actively promoting the utilization of data accumulated in business. In data utilization, a data analyst performs analysis for data utilization using a data flow indicating the flow of data processing.

As a technology for assisting design work in the related art, there is a design work assistance apparatus which realizes design work guidance utilizing past design work cases. The design work assistance apparatus accumulates information relating to design work history, for example, information relating to failure cases. Based on the accumulated information, the design work assistance apparatus issues a warning about the failure cases to a design worker in advance and timely so that the same failure is not repeated.

As a technology in the related art, there is an information management and tracking system for managing and tracking artifact data relating to the development of a process. The artifact data includes data relating to development experiment parameters, results, and products. The information management and tracking system includes a data management unit and a process design environment for retaining data relating to the process design, a development tracking environment, and a back annotation environment. The development tracking environment retains data relating to the process development, including artifacts. The back annotation environment receives process data and provides the process data to the development tracking environment. The data management unit is configured to control the process design environment, the development tracking environment, and the back annotation environment. The data received and stored in these environments is accessible in a linked manner such that, in use of this information management and tracking system, a user may obtain data from each environment in a state in which links between the environments are displayed.

As a technology in the related art, there is a maintenance work procedure data management apparatus capable of providing information on appropriate maintenance work in accordance with the condition of work time while reducing labor of the maintenance worker. This maintenance work procedure data management apparatus extracts a maintenance work procedure corresponding to fault content of maintenance work reception information from a maintenance work procedure database of a storage unit when the maintenance work reception information is acquired from an information terminal input unit. This maintenance work procedure data management apparatus generates maintenance work procedure data including the extracted maintenance work procedure. The maintenance work procedure includes a plurality of procedures associated with priority and work time. This maintenance work procedure data management apparatus performs processing to delete at least the procedure having the lowest priority among the plurality of procedures in the maintenance work procedure included in the generated maintenance work procedure data so that a standard work time in the maintenance work procedure database is within a specified work time when the standard work time is longer than the specified work time in the maintenance work reception information. For example, Japanese Laid-open Patent Publication No. 2003-303213, Japanese National Publication of International Patent Application No. 2007-534051, and Japanese Laid-open Patent Publication No. 2017-224133 are disclosed as the related art.

### SUMMARY

According to an aspect of the embodiments, an information processing apparatus, includes a memory; and a processor coupled to the memory and configured to: count a number of first data flows which a second data flow related to a current data flow has, repeat a replacement processing which replaces the current data flow with the second data flow until the counted number of first data flows is not 1, when the number of first data flows of the second data flow is not 1, identify the second data flow as the current data flow, and display the identified current data flow on a display device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a return function to a fulcrum flow by a data flow editing apparatus according to an embodiment;

FIG. 2 is a diagram illustrating a functional configuration of the data flow editing apparatus according to the embodiment;

FIG. 3 is a diagram illustrating an example of adding names of parent and child data flows;

FIG. 4 is a diagram illustrating an example of a flow information storage unit;

FIG. 5A is a first diagram illustrating a return example by a return unit;

FIG. 5B is a second diagram illustrating a return example by the return unit;

FIG. 5C is a third diagram illustrating a return example by the return unit;

FIG. 6 is a flowchart illustrating flow of processing by a generation unit in response to an instruction to generate a child;

FIG. 7 is a flowchart illustrating flow of current moving processing;

FIG. 8 is a diagram illustrating an example of child generation;

FIG. 9 is a flowchart illustrating flow of processing by the return unit;

FIG. 10 is a diagram illustrating a hardware configuration of a computer that executes a data flow editing program according to an embodiment; and

FIG. 11 is a diagram for explaining trial and error of data analysis.

### DESCRIPTION OF EMBODIMENTS

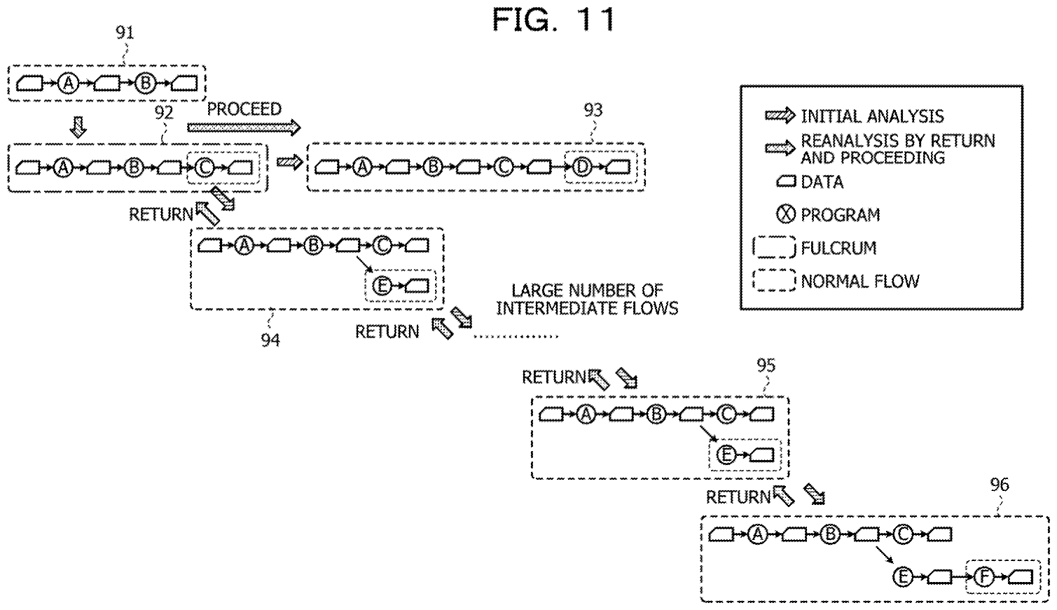

Analysis for data utilization is performed by trial and error. For example, the data analyst frequently returns to the past analysis and performs reanalysis in the course of analysis. FIG. 11 is a diagram for explaining trial and error of data analysis. As illustrated in FIG. 11, a data flow 91 is first created. In the data flow 91, data is processed by a program A and a processing result is output. The processing result by the program A is processed by a program B, and a processing result is output.

Next, a data flow 92 is created. In the data flow 92, a program C for processing the processing result by the program B and outputting a processing result is added. Next, a data flow 93 is created. In the data flow 93, a program D for processing the processing result by the program C and outputting a processing result is added.

Another analysis is performed using the data flow 92 as a fulcrum flow, and a data flow 94 is created. The fulcrum flow is a data flow serving as a starting point of two or more analyses. In the data flow 94, a program E for processing the processing result by the program B and outputting a processing result is added. Similar analysis is performed to create a data flow 95, a data flow 96, and the like. As a result, the data flow 91 to the data flow 96 and the like are created as the first analysis. Thereafter, return by trial and error occurs, and for example, return from the data flow 96 to the data flow 95, return from the data flow 94 to the data flow 92, and the like occur.

In the case of returning to the fulcrum flow in order to perform another analysis from the fulcrum flow in the course of trial and error, the data analyst repeats the operation to return to the parent flow one by one if there are a large number of intermediate flows between the current flow and the fulcrum flow that is the return destination. Hence, it takes time to return to the fulcrum flow, and there is a problem that the efficiency of analysis is poor. The current flow is a data flow currently being edited, the intermediate flow is a data flow between the current flow and the fulcrum flow, and the parent flow is a parent data flow of the current flow.

In view of the above, in one aspect, it is desired to enable easy return to the fulcrum flow in the course of trial and error of data analysis and to improve the efficiency of data analysis.

Hereinafter, an embodiment of an information processing apparatus, a data flow editing method, and a data flow editing program disclosed in the present application will be described in detail with reference to the drawings. Note that this embodiment does not limit the disclosed technology.

### Embodiment

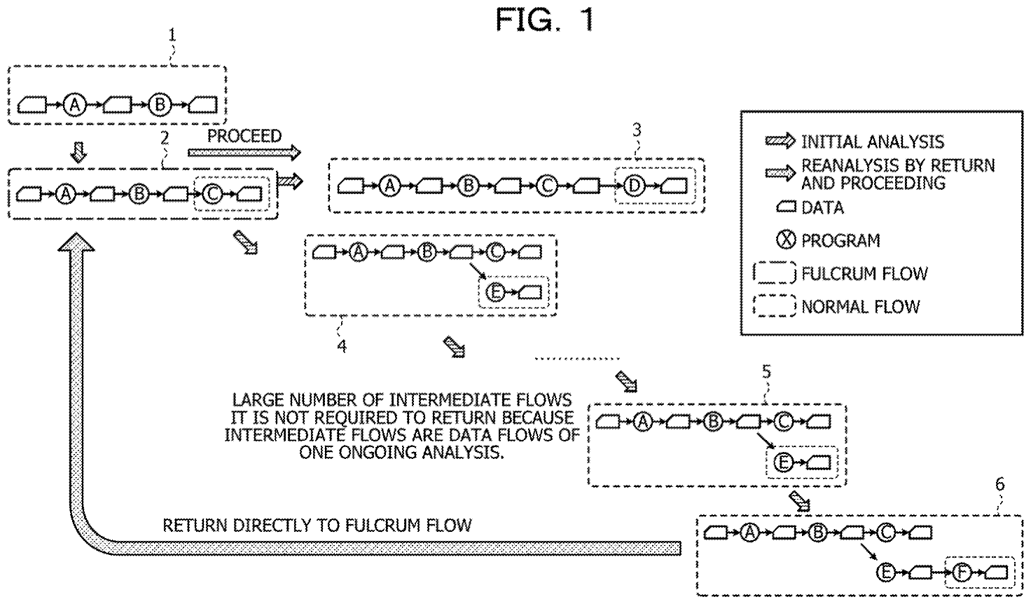

First, a return function to a fulcrum flow by a data flow editing apparatus according to an embodiment will be described. FIG. 1 is a diagram for explaining the return function to the fulcrum flow by the data flow editing apparatus according to the embodiment. In FIG. 1, the analysis is advanced using a data flow 2 as the fulcrum flow, data flows such as data flows 3 to 6 are created, and the data flow 6 is the current data flow being edited.

As illustrated in FIG. 1, the data flow editing apparatus according to the embodiment provides a function to directly return from the data flow 6 which is the current flow to the data flow 2 which is the fulcrum flow. Hence, the data analyst may easily return to the fulcrum flow without repeating the operation to return to the parent flow one by one.

In this manner, the data flow editing apparatus according to the embodiment provides the function to directly return to the fulcrum flow, and thus the efficiency of data analysis may be improved.

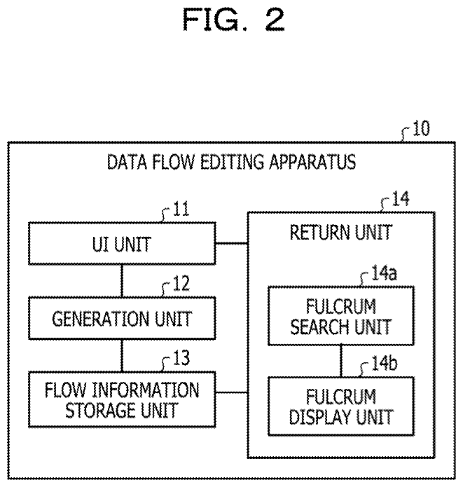

Next, the functional configuration of the data flow editing apparatus according to the embodiment will be described. FIG. 2 is a diagram illustrating the functional configuration of the data flow editing apparatus according to the embodiment. As illustrated in FIG. 2, a data flow editing apparatus 10 according to the embodiment includes a user interface (UI) unit 11, a generation unit 12, a flow information storage unit 13, and a return unit 14.

The UI unit 11 displays a data flow editing screen on a display device and receives an instruction from the data analyst. The UI unit 11 requests another functional unit to perform processing based on the received instruction. For example, the UI unit 11 requests the generation unit 12 to generate a data flow in response to an instruction to generate a data flow. The UI unit 11 requests the return unit 14 to return the data flow in response to an instruction to return.

The generation unit 12 generates a data flow by interacting with the data analyst via the UI unit 11 and stores information on the generated data flow in the flow information storage unit 13 as flow information. When generating a child flow, the generation unit 12 adds the name of the child to the flow information of the parent flow and adds the name of the parent to the flow information of the child flow. The child flow is a child data flow of the current flow.

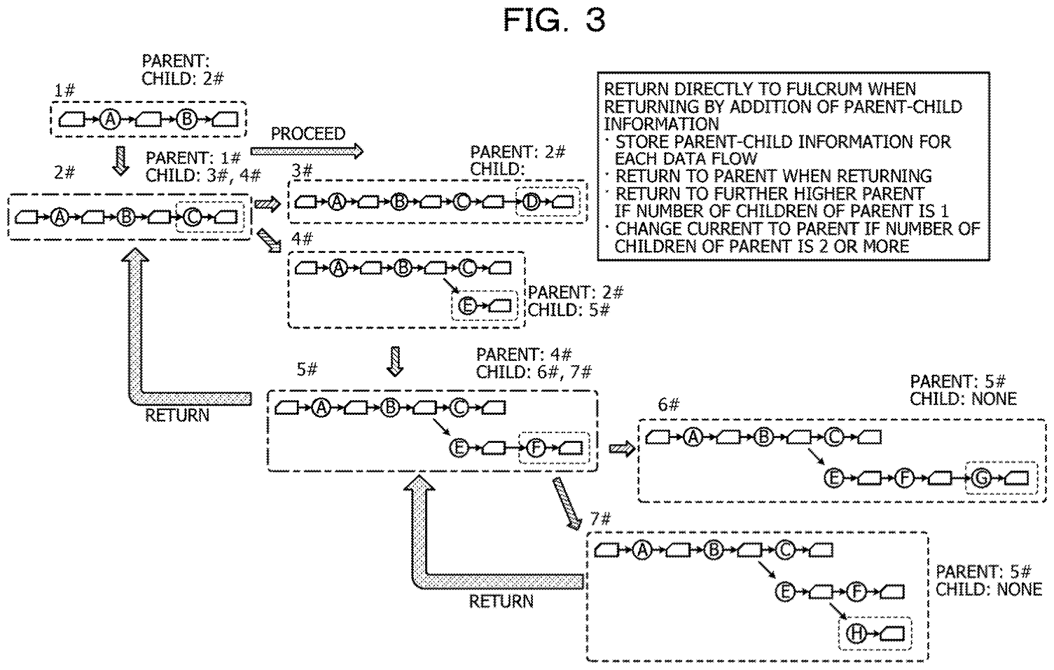

FIG. 3 is a diagram illustrating an example of adding the names of parent and child data flows. In FIG. 3, “1#”, “2#”, and the like added to the upper left of the respective data flows are the names of data flows. As illustrated in FIG. 3, the name “#2” of the child flow is added to the flow information of the data flow “1#”. In the flow information of the data flow “2#”, the name “1#” of the parent flow and the names “3#” and “4#” of the child flows are added.

Similarly, the name “2#” of the parent flow is added to the flow information of the data flow “3#”. The name “2#” of the parent flow and the name “5#” of the child flow are added to the flow information of the data flow “4#”. Similarly, parent-child information is added to the data flows “5#”, “6#”, and “7#”.

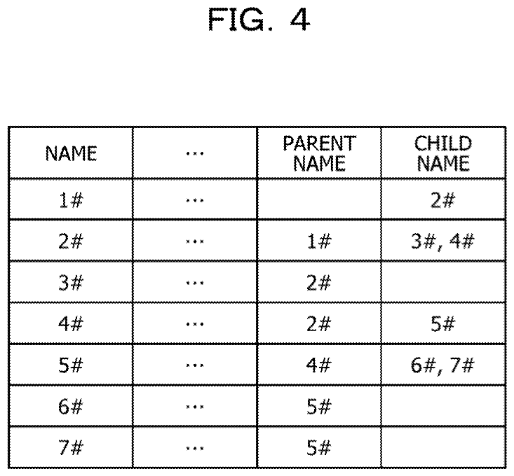

The flow information storage unit 13 stores flow information. FIG. 4 is a diagram illustrating an example of the flow information storage unit 13. As illustrated in FIG. 4, the flow information storage unit 13 stores the name, . . . , the parent name, and the child name for each data flow. The name is the name of the data flow. The parent name is the name of the parent flow. The child name is the name of the child flow. For example, a data flow named “1#” does not have a parent flow but has a data flow named “2#” as a child. The flow information storage unit 13 stores, for each data flow, information on the data flow diagram as other information.

The return unit 14 returns the current flow to the fulcrum flow based on the parent-child information stored in the flow information storage unit 13. The return unit 14 includes a fulcrum search unit 14a and a fulcrum display unit 14b.

The fulcrum search unit 14a searches for the closest fulcrum flow from the ancestor data flows of the current flow. For example, the fulcrum search unit 14a repeats replacement of the current flow with the parent flow until the number of children of the parent flow of the current flow is not 1. As illustrated in FIG. 3, when the number of children of the parent flow of the current flow is 1, the parent flow is not the fulcrum flow. On the other hand, when the number of children of the parent flow of the current flow is 2 or more, the parent flow is the fulcrum flow.

When the number of children of the parent flow of the current flow is not 1 by the repetition of replacement by the fulcrum search unit 14a, the fulcrum display unit 14b displays the parent flow as the current flow via the UI unit 11.

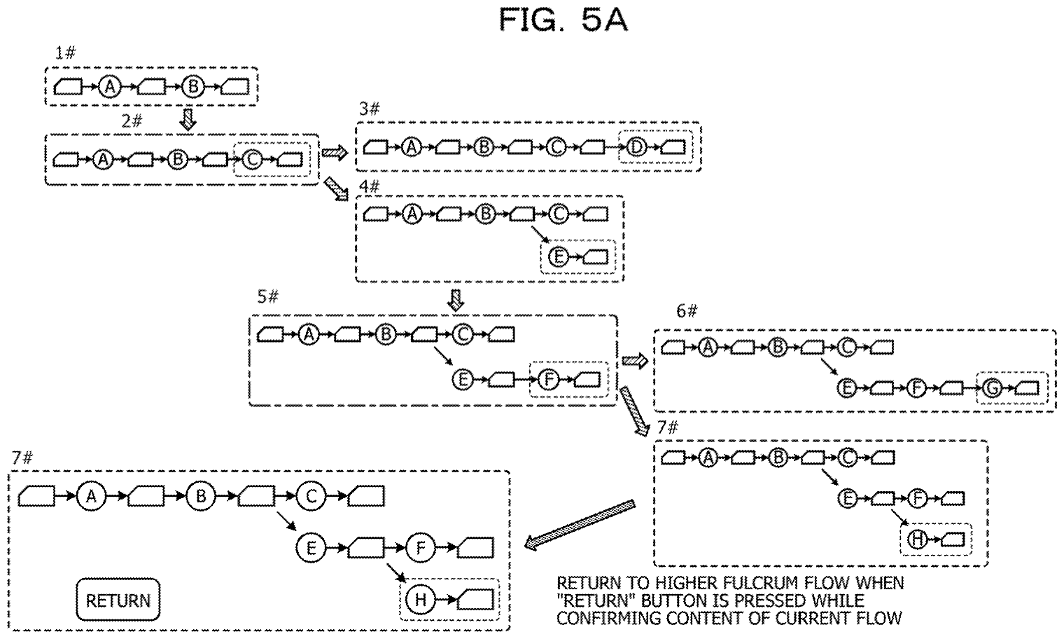

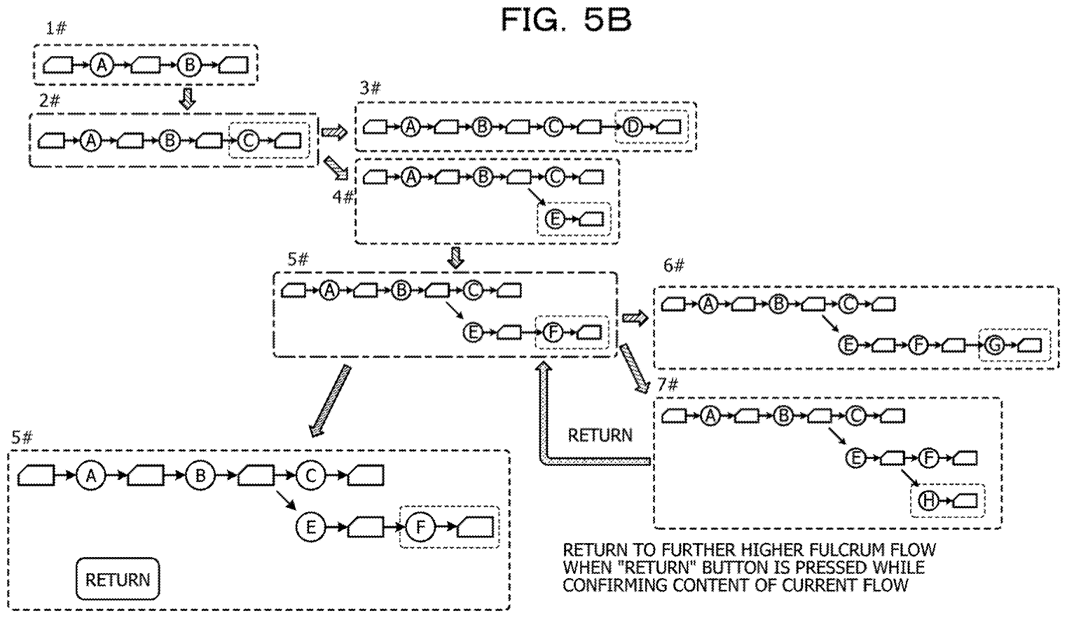

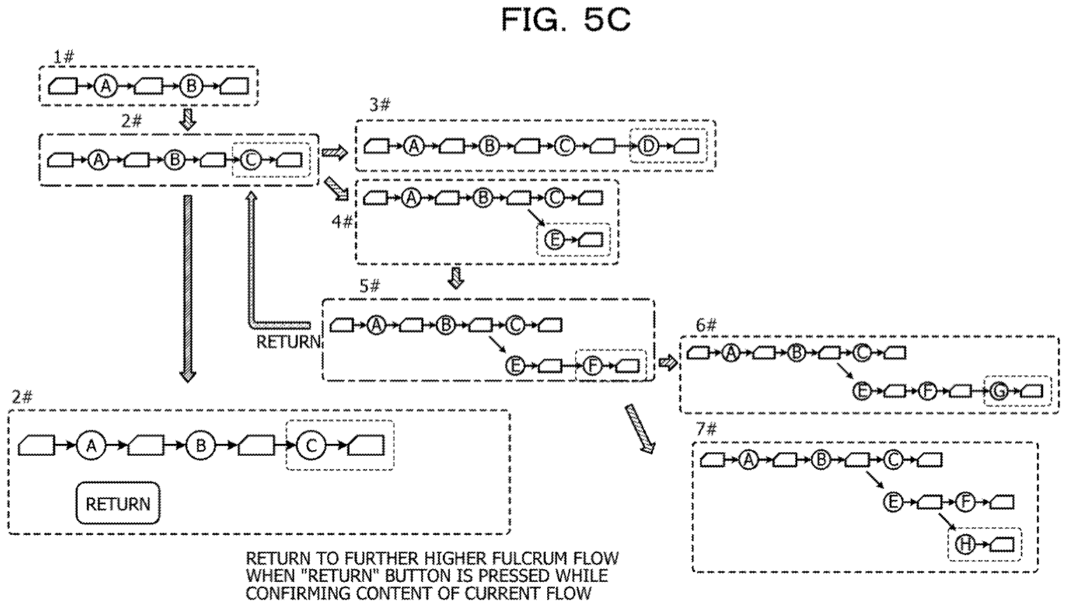

FIGS. 5A to 5C are diagrams illustrating examples of return by the return unit 14. As illustrated in FIG. 5A, when a “return” button is pressed in the data flow “7#” that is the current flow, the data flow “5#” that is the fulcrum flow becomes the current flow as illustrated in FIG. 5B since the number of children of the parent flow “5#” is 2.

When the “return” button is pressed in the data flow “5#” that is the current flow, the number of children of the parent flow “2#” of the data flow “4#” is determined since the number of children of the parent flow “4#” is 1. Since the number of children of the data flow “2#” is 2, the data flow “2#” that is the fulcrum flow becomes the current flow as illustrated in FIG. 5C.

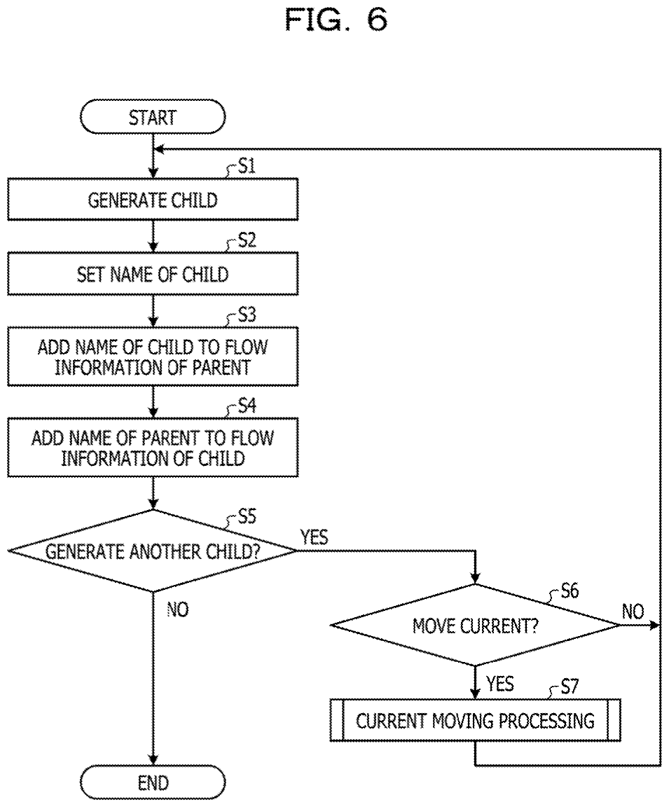

Next, the flow of processing by the generation unit 12 in response to an instruction to generate a child will be described. FIG. 6 is a flowchart illustrating the flow of processing by the generation unit 12 in response to an instruction to generate a child. As illustrated in FIG. 6, the generation unit 12 generates a child (step S1) and sets the name of the child (step S2).

The generation unit 12 then adds the name of the child to the flow information of the parent (step S3) and adds the name of the parent to the flow information of the child (step S4). The generation unit 12 then determines whether or not to generate another child (step S5) and ends the processing when another child is not to be generated. On the other hand, when another child is to be generated, the generation unit 12 determines whether or not to move the current flow (step S6) and performs current moving processing (step S7) when the current flow is to be moved. The processing then returns to step S1, and the generation unit 12 creates another child under the current flow.

In this manner, when the generation unit 12 generates a child, the generation unit 12 adds the name of the child to the flow information of the parent and the name of the parent to the flow information of the child. The return unit 14 may thus perform processing to return to the fulcrum flow using the flow information. The generation unit 12 may edit the generated child data flow between step S4 and step S5 while interacting with the data analyst via the UI unit 11.

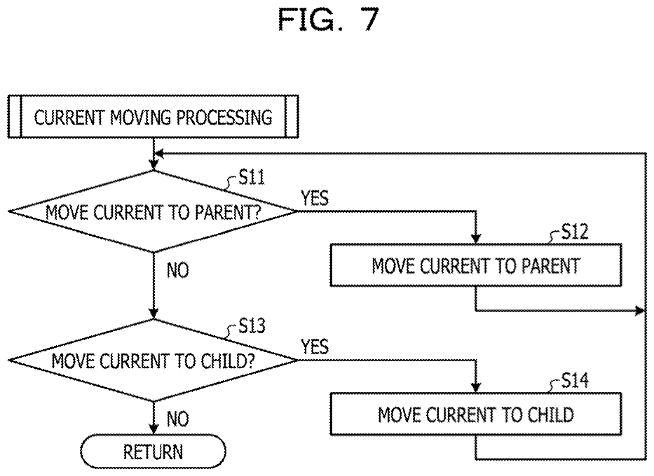

FIG. 7 is a flowchart illustrating the flow of the current moving processing. As illustrated in FIG. 7, the generation unit 12 determines whether or not to move the current flow to the parent (step S11). When it is determined to move the current flow to the parent, the generation unit 12 moves the current flow to the parent (step S12). The processing then returns to step S11.

On the other hand, when it is determined not to move the current flow to the parent, the generation unit 12 determines whether or not to move the current flow to the child (step S13). When it is determined not to move the current flow to the child, the generation unit 12 ends the current moving processing. On the other hand, when it is determined to move the current flow to the child, the generation unit 12 moves the current flow to the child (step S14). The processing then returns to step S11.

The generation unit 12 determines whether or not to move the current flow to the parent and the child by receiving an instruction from the data analyst via the UI unit 11.

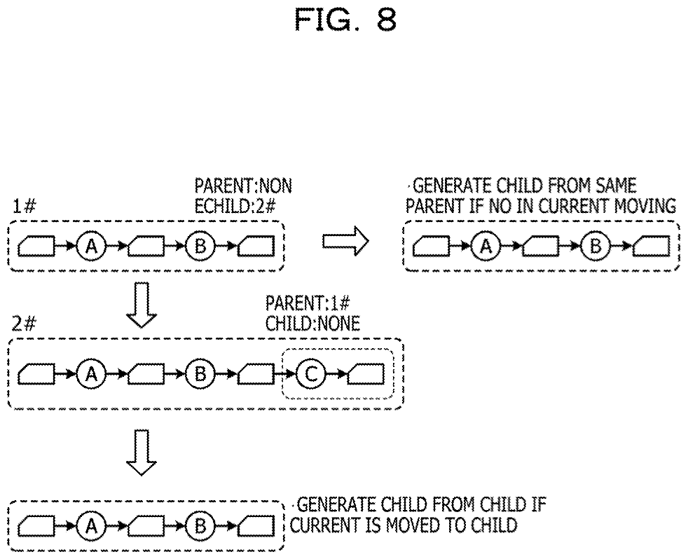

FIG. 8 is a diagram illustrating an example of child generation. In FIG. 8, the data flow 1# is the current flow and the data flow 2# is the generated child. As illustrated in FIG. 8, the name “1#” of the parent flow is added to the flow information of the generated data flow 2# and the name “2#” of the child flow is added to the flow information of the data flow 1#.

After the data flow 2# is generated, another child is generated from the data flow 1# when the current flow is not moved. A child is generated from the data flow 2# when the current flow is moved to the data flow 2# that is the child.

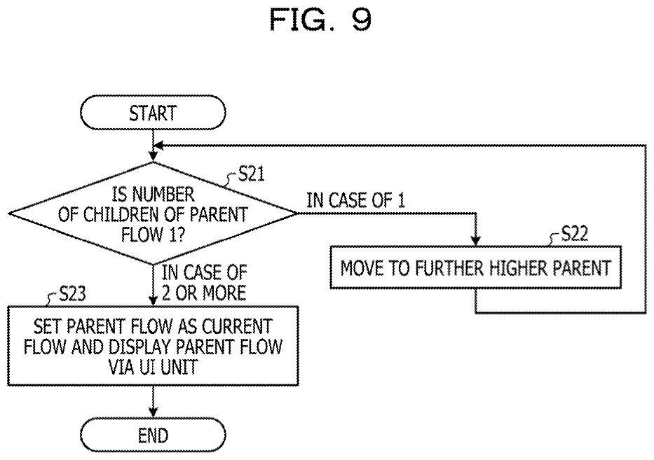

Next, the flow of processing by the return unit 14 will be described. FIG. 9 is a flowchart illustrating the flow of processing by the return unit 14. As illustrated in FIG. 9, the return unit 14 determines whether or not the number of children of the parent flow is 1 (step S21). When the number of children of the parent flow is 1, the return unit 14 moves to a further higher parent (step S22).

The processing then returns to step S21. On the other hand, when the number of children of the parent flow is not 1, the return unit 14 designates the parent flow as the current flow and displays the parent flow via the UI unit 11 (step S23).

In this manner, the return unit 14 skips the intermediate flow(s) and returns the current flow to the fulcrum flow for display, and the data analyst may thus efficiently return to the fulcrum flow.

As described above, in the embodiment, the fulcrum search unit 14a repeats replacement of the current flow with the parent flow until the number of children of the parent flow of the current flow is not 1. When the number of children of the parent flow of the current flow is not 1 by the repetition of replacement by the fulcrum search unit 14a, the fulcrum display unit 14b displays the parent flow as the current flow via the UI unit 11. Hence, the data flow editing apparatus 10 may return the current flow to the closest fulcrum flow and improve the efficiency of data analysis by the data analyst.

In the embodiment, the fulcrum search unit 14a repeats replacement of the current flow with the parent flow based on the parent name and child name included in the flow information stored in the flow information storage unit 13. Hence, the fulcrum search unit 14a may efficiently search for the closest fulcrum flow among the ancestor data flows.

In the embodiment, the data flow editing apparatus 10 has been described, but it is possible to obtain a data flow editing program having similar functions by implementing the configuration of the data flow editing apparatus 10 by software. A computer that executes the data flow editing program will now be described.

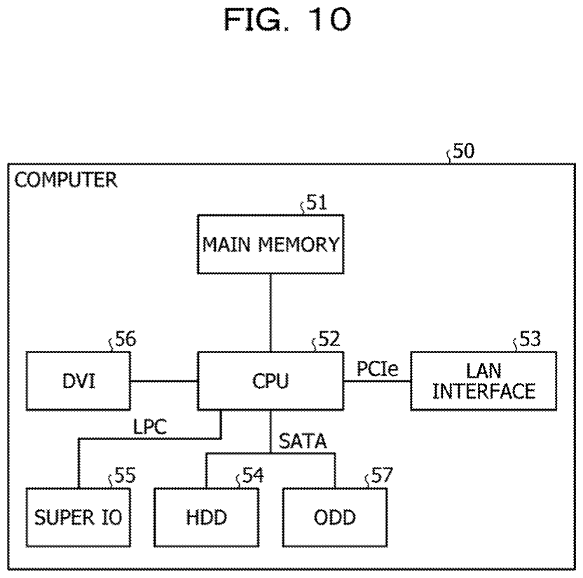

FIG. 10 illustrates a hardware configuration of the computer that executes the data flow editing program according to the embodiment. As illustrated in FIG. 10, a computer 50 includes a main memory 51, a central processing unit (CPU) 52 which is an example of a processor, a local area network (LAN) interface 53, and a hard disk drive (HDD) 54. The computer 50 further includes a super input output (10) 55, a digital visual interface (DVI) 56, and an optical disk drive (ODD) 57.

The main memory 51 is a memory that stores a program, halfway results of program execution, and the like. The CPU 52 is a central processing unit that reads the program from the main memory 51 and executes the program. The CPU 52 includes a chipset including a memory controller.

The LAN interface 53 is an interface that couples the computer 50 to another computer through the LAN. The HDD 54 is a disk device that stores a program and data. The super IO 55 is an interface that couples input devices such as a mouse and a keyboard to the computer 50. The DVI 56 is an interface that couples a liquid crystal display device to the computer 50. The ODD 57 is a device that performs reading and writing of a digital versatile disc (DVD) and a compact disc-recordable (CD-R).

The LAN interface 53 is coupled to the CPU 52 by Peripheral Component Interconnect Express (PCIe). The HDD 54 and the ODD 57 are coupled to the CPU 52 by Serial Advanced Technology Attachment (SATA). The super IO 55 is coupled to the CPU 52 by low pin count (LPC).

The data flow editing program executed by the computer 50 is stored on a CD-R which is an example of a recording medium that is readable by the computer 50, is read from the CD-R by the ODD 57, and is installed in the computer 50. Alternatively, the data flow editing program is stored in databases or the like of another computer system coupled through the LAN interface 53, is read from these databases, and is installed in the computer 50. The data flow editing program thus installed is stored in the HDD 54, is read to the main memory 51, and is executed by the CPU 52.

The data flow editing program may be operated in a cloud system. In this case, the cloud system provides a data flow editing service, and the data analyst edits the data flow using the data flow editing service provided by the cloud system.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and configured to:
count a number of first data flows which a second data flow related to a current data flow has,
repeat a replacement processing which replaces the current data flow with the second data flow until the counted number of first data flows is not 1,
when the number of first data flows of the second data flow is not 1, identify the second data flow as the current data flow, and
display the identified current data flow on a display device.

2. The information processing apparatus according to claim 1, wherein the processor is configured to:
store, for each data flow in the memory, flow information that includes information on a second data flow and information on a first data flow, and
repeat the replacement based on the flow information stored in the memory.

3. The information processing apparatus according to claim 1, wherein the processor is configured to:
include information on a second data flow and information on a first data flow in flow information when generating the first data flow.

4. A data flow editing method executed by a computer, the data flow editing method comprising:
counting a number of first data flows which a second data flow related to a current data flow has,
repeating a replacement processing which replaces the current data flow with the second data flow until the counted number of first data flows is not 1,
when the number of first data flows of the second data flow is not 1, identify the second data flow as the current data flow, and
displaying the identified current data flow on a display device.

5. A non-transitory computer-readable storage medium storing a program that causes a computer to execute a process, the process comprising:
counting a number of first data flows which a second data flow related to a current data flow has,
repeating a replacement processing which replaces the current data flow with the second data flow until the counted number of first data flows is not 1,
when the number of first data flows of the second data flow is not 1, identify the second data flow as the current data flow, and
displaying the identified current data flow on a display device.
